(19) United States
(12) Patent Application Publication
(10) Pub. No.: US 2012/0175809 A1
(43) Pub. Date: Jul. 12, 2012

(54) Process for Making Crosslinked Injection Molded Articles

(75) Inventors: Mohamed Esseghir, Monroe Township, NJ (US); Saurav S. Sengupta, Somerset, NJ (US)

(73) Assignee: Union Carbide Chemicals & Plastics Technology LLC, Midland, MI (US)

(21) Appl. No.: 13/496,523

(22) PCT Filed: Sep. 14, 2010
(86) PCT No.: PCT/US10/48704

§ 371 Date: Mar. 16, 2012

Related U.S. Application Data
(60) Provisional application No. 61/243,724, filed on Sep. 18, 2009.

(51) Int. Cl. B29C 45/00; B29C 45/72

(52) U.S. Cl. 264/235

(57) ABSTRACT

An injection molding process for making a plastic article, the process comprising the steps of: A. Forming a moisture-curable composition comprising a 1. Silane-functionalized polyethylene, 2. Moisture source, e.g., a moisture-containing filler, wherein the moisture source excludes alcohols, and 3. Condensation catalyst; B. Injecting the composition into a mold; C. Subjecting the composition to conditions sufficient to 1. Release moisture from the moisture source, and 2. Partially cure the composition; D. Removing the partially cured composition from the mold; and E. Continuing the cure of the composition outside of the mold. The process is particularly well suited for the manufacture of thick parts, such as wire and cable elastomeric connectors.

### CROSS-REFERENCE TO RELATED APPLICATIONS

This application claims priority to U.S. Patent Application No. 61/243,724 filed on Sep. 18, 2009, the entire content of which is incorporated by reference herein.

### FIELD OF THE INVENTION

This invention relates to a process for making injection molded articles. In one aspect, the invention relates to such a process in which a moisture-curable composition is injected into a mold and subjected to partial-curing conditions while in another aspect, the invention relates to completing the cure outside of the mold. In still another aspect, the invention relates to making thick-walled injection molded articles.

### BACKGROUND OF THE INVENTION

Thermoplastic compositions, e.g., silane-functionalized polyolefins, particularly silane-functionalized polyethylene, used in making molded articles that require cross-linking through the use of organic peroxide need to be processed at low temperatures in a melt state in order to avoid premature cross-linking prior to forming the part in the mold. In addition, many such compositions contain fillers for either reinforcement or for other properties (e.g. electrical conductivity). Such fillers generally result in a substantial increase in compound viscosity, i.e., they become harder to process and are more prone to heat generation due to viscous energy dissipation. This, in turn, leads to an increased probability of premature scorch, thus the need to run the melt processing operation at low rates to prevent reaching unacceptable temperatures. During the injection molding process, once the article is formed, it needs to be held in the mold for sufficient time at an appropriate peroxide decomposition temperature to achieve full cross-linking. This is, in part, due to poor heat transfer through the article walls, especially in case of thick parts such as electrical connectors. The combined problems of premature scorch and long mold-cure time result in a long manufacturing cycle, thus low productivity (units per time).

### SUMMARY OF THE INVENTION

In one embodiment, the invention is an injection molding process for making a plastic article, the process comprising the steps of:

A. Forming a moisture-curable composition comprising a
1. Silane-functionalized polyethylene,
2. Moisture source, wherein the moisture source excludes alcohols, and
3. Condensation catalyst;

B. Injecting the composition into a mold;

C. Subjecting the composition to conditions sufficient to
1. Release moisture from the moisture source, and
2. Partially cure the composition;

D. Removing the partially cured composition from the mold; and

E. Continuing the cure of the composition outside of the mold.

In one embodiment the moisture-containing source is a moisture-containing filler while in another embodiment, the moisture is generated either via physical release, such as from a salt (e.g., magnesium oxalate dihydrate), or a chemical reaction.

The invention is particularly well suited for the manufacture of thick parts, such as wire and cable elastomeric connectors, because the compositions used to make these parts are filled systems with high viscosity and thus prone to scorch. However, this thickness also makes these parts well suited for moisture cure using internally generated moisture that can diffuse through the part over time and thus continue and complete the cure outside of the mold. Moisture cure systems that rely on moisture generated externally from the part require additional equipment and process steps such as passing the part through a bath or steam chamber.

In one embodiment the invention employs peroxide to induce partial crosslinking within the mold to promote de-molding (integrity of part geometry) followed by an off-mold moisture cure (which too can begin within the mold). This takes completion of the cure step out of the mold, thus freeing the mold to make more parts. This approach improves the manufacturing cycle and achieves higher productivity.

### BRIEF DESCRIPTION OF THE DRAWINGS

FIG. 1 is a graph reporting the comparative torque increase for Examples 1-3.

FIG. 2 is a graph reporting the crosslinking temperature profile for Example 2.

FIG. 3 is a graph reporting the crosslinking temperature profile for Example 3.

### DETAILED DESCRIPTION OF THE PREFERRED EMBODIMENT

Unless stated to the contrary, implicit from the context, or customary in the art, all parts and percents are based on weight and all test methods are current as of the filing date of this disclosure. For purposes of United States patent practice, the contents of any referenced patent, patent application or publication are incorporated by reference in their entirety (or its equivalent US version is so incorporated by reference) especially with respect to the disclosure of synthetic techniques, definitions (to the extent not inconsistent with any definitions specifically provided in this disclosure), and general knowledge in the art.

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. As an example, if a compositional, physical or other property, such as, for example, molecular weight, viscosity, melt index, etc., is from 100 to 1,000, it is intended that all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, the component amounts of the composition and various process parameters.

“Cable” and like terms mean at least one wire or optical fiber within a protective insulation, jacket or sheath. Typically, a cable is two or more wires or optical fibers bound together, typically in a common protective insulation, jacket or sheath. The individual wires or fibers inside the jacket may be bare, covered or insulated. Combination cables may contain both electrical wires and optical fibers. The cable, etc. can be designed for low, medium and high voltage applications. Typical cable designs are illustrated in U.S. Pat. Nos. 5,246,783, 6,496,629 and 6,714,707.

“Polymer” means a compound prepared by reacting (i.e., polymerizing) monomers, whether of the same or a different type. The generic term polymer thus embraces the term “homopolymer”, usually employed to refer to polymers prepared from only one type of monomer, and the term “interpolymer” as defined below.

“Interpolymer” and “copolymer” mean a polymer prepared by the polymerization of at least two different types of monomers. These generic terms include both classical copolymers, i.e., polymers prepared from two different types of monomers, and polymers prepared from more than two different types of monomers, e.g., terpolymers, tetrapolymers, etc.

“Ethylene polymer”, “polyethylene” and like terms mean a polymer containing units derived from ethylene. Ethylene polymers typically comprise at least 50 mole percent (mol %) units derived from ethylene.

“Ethylene-vinylsilane polymer” and like terms mean an ethylene polymer comprising silane functionality. The silane functionality can be the result of either polymerizing ethylene with a vinyl silane, e.g., a vinyl trialkoxy silane comonomer, or, grafting such a comonomer onto an ethylene polymer backbone as described, for example, in U.S. Pat. No. 3,646,155 or 6,048,935.

“Blend,” “polymer blend” and like terms mean a blend of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art.

“Composition” and like terms mean a mixture or blend of two or more components. For example, in the context of preparing a silane-grafted ethylene polymer, a composition would include at least one ethylene polymer, at least one vinyl silane, and at least one free radical initiator. In the context of preparing a cable sheath or other article of manufacture, a composition would include an ethylene-vinylsilane copolymer, a catalyst cure system and any desired additives such as lubricants, fillers, anti-oxidants and the like.

“Ambient conditions” and like terms means a temperature of 23° C. and atmospheric pressure.

“Catalytic amount” means an amount of catalyst necessary to promote the crosslinking of an ethylene-vinylsilane polymer at a detectable level, preferably at a commercially acceptable level.

“Crosslinked”, “cured” and similar terms mean that the polymer, before or after it is shaped into an article, was subjected or exposed to a treatment which induced crosslinking and has xylene or decalene extractables of less than or equal to 90 weight percent (i.e., greater than or equal to 10 weight percent gel content).

“Crosslinkable”, “curable” and like terms means that the polymer, before or after shaped into an article, is not cured or crosslinked and has not been subjected or exposed to treatment that has induced substantial crosslinking although the polymer comprises additive(s) or functionality which will cause or promote substantial crosslinking upon subjection or exposure to such treatment (e.g., exposure to water).

Ethylene Polymers

The polyethylenes used in the practice of this invention, i.e., the polyethylenes that contain copolymerized silane functionality or are subsequently grafted with a silane, can be produced using conventional polyethylene polymerization technology, e.g., high-pressure, Ziegler-Natta, metallocene or constrained geometry catalysis. In one embodiment, the polyethylene is made using a high pressure process. In another embodiment, the polyethylene is made using a mono- or bis-cyclopentadienyl, indenyl, or fluorenyl transition metal (preferably Group 4) catalysts or constrained geometry catalysts (CGC) in combination with an activator, in a solution, slurry, or gas phase polymerization process. The catalyst is preferably mono-cyclopentadienyl, mono-indenyl or mono-fluorenyl CGC. The solution process is preferred. U.S. Pat. No. 5,064,802, WO93/19104 and WO95/00526 disclose constrained geometry metal complexes and methods for their preparation. Variously substituted indenyl containing metal complexes are taught in WO95/14024 and WO98/49212.

In general, polymerization can be accomplished at conditions well-known in the art for Ziegler-Natta or Kaminsky-Sinn type polymerization reactions, that is, at temperatures from 0-250° C., preferably 30-200° C., and pressures from atmospheric to 10,000 atmospheres (1013 megaPascal (MPa)). Suspension, solution, slurry, gas phase, solid state powder polymerization or other process conditions may be employed if desired. The catalyst can be supported or unsupported, and the composition of the support can vary widely. Silica, alumina or a polymer (especially poly(tetrafluoroethylene) or a polyolefin) are representative supports, and desirably a support is employed when the catalyst is used in a gas phase polymerization process. The support is preferably employed in an amount sufficient to provide a weight ratio of catalyst (based on metal) to support within a range of from 1:100,000 to 1:10, more preferably from 1:50,000 to 1:20, and most preferably from 1:10,000 to 1:30. In most polymerization reactions, the molar ratio of catalyst to polymerizable compounds employed is from 10-12:1 to 10-1:1, more preferably from 10⁻⁹:1 to 10⁻⁵:1.

Inert liquids serve as suitable solvents for polymerization. Examples include straight and branched-chain hydrocarbons such as isobutane, butane, pentane, hexane, heptane, octane, and mixtures thereof; cyclic and alicyclic hydrocarbons such as cyclohexane, cycloheptane, methylcyclohexane, methylcycloheptane, and mixtures thereof; perfluorinated hydrocarbons such as perfluorinated C₄₋₁₀ alkanes; and aromatic and alkyl-substituted aromatic compounds such as benzene, toluene, xylene, and ethylbenzene.

The ethylene polymers useful in the practice of this invention include ethylene/α-olefin interpolymers having a α-olefin content of between about 15, preferably at least about 20 and even more preferably at least about 25, wt % based on the weight of the interpolymer. These interpolymers typically have an α-olefin content of less than about 50, preferably less than about 45, more preferably less than about 40 and even more preferably less than about 35, wt % based on the weight of the interpolymer. The α-olefin content is measured by ¹³C nuclear magnetic resonance (NMR) spectroscopy using the procedure described in Randall (Rev. Macromol. Chem. Phys., C29 (2&3)). Generally, the greater the α-olefin content of the interpolymer, the lower the density and the more amorphous the interpolymer, and this translates into desirable physical and chemical properties for the crosslinked injection molded article.

The α-olefin is preferably a C₃₋₂₀ linear, branched or cyclic α-olefin. Examples of C₃₋₂₀ α-olefins include propene, 1-butene, 4-methyl-1-pentene, 1-hexene, 1-octene, 1-decene, 1-dodecene, 1-tetradecene, 1-hexadecene, and 1-octadecene. The α-olefins also can contain a cyclic structure such as cyclohexane or cyclopentane, resulting in an α-olefin such as 3-cyclohexyl-1-propene (allyl cyclohexane) and vinyl cyclohexane. Although not α-olefins in the classical sense of the term, for purposes of this invention certain cyclic olefins, such as norbornene and related olefins, particularly 5-ethylidene-2-norbornene, are α-olefins and can be used in place of some or all of the α-olefins described above. Similarly, styrene and its related olefins (for example, α-methylstyrene, etc.) are α-olefins for purposes of this invention. Illustrative ethylene polymers include ethylene/propylene, ethylene/butene, ethylene/1-hexene, ethylene/1-octene, ethylene/styrene, and the like. Illustrative terpolymers include ethylene/propylene/1-octene, ethylene/propylene/butene, ethylene/butene/1-octene, ethylene/propylene/diene monomer (EPDM) and ethylene/butene/styrene. The copolymers can be random or blocky.

The ethylene polymers used in the practice of this invention can be used alone or in combination with one or more other ethylene polymers, e.g., a blend of two or more ethylene polymers that differ from one another by monomer composition and content, catalytic method of preparation, etc. If the ethylene polymer is a blend of two or more ethylene polymers, then the ethylene polymer can be blended by any in-reactor or post-reactor process. The in-reactor blending processes are preferred to the post-reactor blending processes, and the processes using multiple reactors connected in series are the preferred in-reactor blending processes. These reactors can be charged with the same catalyst but operated at different conditions, e.g., different reactant concentrations, temperatures, pressures, etc, or operated at the same conditions but charged with different catalysts.

Examples of ethylene polymers made with high pressure processes include (but are not limited to) low density polyethylene (LDPE), ethylene silane reactor copolymer (such as SiLINK® made by The Dow Chemical Company), ethylene vinyl acetate copolymer (EVA), ethylene ethyl acrylate copolymer (EEA), and ethylene silane acrylate terpolymers.

Examples of ethylene polymers that can be grafted with silane functionality include very low density polyethylene (VLDPE) (e.g., FLEXOMER® ethylene/1-hexene polyethylene made by The Dow Chemical Company), homogeneously branched, linear ethylene/α-olefin copolymers (e.g., TAFMER® by Mitsui Petrochemicals Company Limited and EXACT® by Exxon Chemical Company), homogeneously branched, substantially linear ethylene/α-olefin polymers (e.g., AFFINITY® and ENGAGE® polyethylene available from The Dow Chemical Company), and ethylene block copolymers (e.g., INFUSE® polyethylene available from The Dow Chemical Company). The more preferred ethylene polymers are the homogeneously branched linear and substantially linear ethylene copolymers. The substantially linear ethylene copolymers are especially preferred, and are more fully described in U.S. Pat. Nos. 5,272,236, 5,278,272 and 5,986,028.

Silane Functionality

Any silane that will effectively copolymerize with ethylene, or graft to and crosslink an ethylene polymer, can be used in the practice of this invention, and those described by the following formula are exemplary:

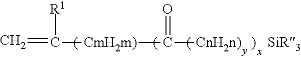

in which R¹ is a hydrogen atom or methyl group; x and y are 0 or 1 with the proviso that when x is 1, y is 1; m and n are independently an integer from 1 to 12 inclusive, preferably 1 to 4, and each R″ independently is a hydrolyzable organic group such as an alkoxy group having from 1 to 12 carbon atoms (e.g. methoxy, ethoxy, butoxy), aryloxy group (e.g. phenoxy), araloxy group (e.g. benzyloxy), aliphatic acyloxy group having from 1 to 12 carbon atoms (e.g. formyloxy, acetyloxy, propanoyloxy), amino or substituted amino groups (alkylamino, arylamino), or a lower alkyl group having 1 to 6 carbon atoms inclusive, with the proviso that not more than one of the three R groups is an alkyl. Such silanes may be copolymerized with ethylene in a reactor, such as a high pressure process. Such silanes may also be grafted to a suitable ethylene polymer by the use of a suitable quantity of organic peroxide, either before or during a shaping or molding operation. Additional ingredients such as heat and light stabilizers, pigments, etc., also may be included in the formulation. The phase of the process during which the crosslinks are created is commonly referred to as the “cure phase” and the process itself is commonly referred to as “curing”. Also included are silanes that add to unsaturation in the polymer via free radical processes such as mercaptopropyl trialkoxysilane.

Suitable silanes include unsaturated silanes that comprise an ethylenically unsaturated hydrocarbyl group, such as a vinyl, allyl, isopropenyl, butenyl, cyclohexenyl or gamma-(meth)acryloxy allyl group, and a hydrolyzable group, such as, for example, a hydrocarbyloxy, hydrocarbonyloxy, or hydrocarbylamino group. Examples of hydrolyzable groups include methoxy, ethoxy, formyloxy, acetoxy, proprionyloxy, and alkyl or arylamino groups. Preferred silanes are the unsaturated alkoxy silanes which can be grafted onto the polymer or copolymerized in-reactor with other monomers (such as ethylene and acrylates). These silanes and their method of preparation are more fully described in U.S. Pat. No. 5,266,627 to Meverden, et al. Vinyl trimethoxy silane (VTMS), vinyl triethoxy silane, vinyl triacetoxy silane, gamma-(meth)acryloxy propyl trimethoxy silane and mixtures of these silanes are the preferred silane crosslinkers for use in this invention. If filler is present, then preferably the crosslinker includes vinyl trialkoxy silane.

The amount of silane crosslinker used in the practice of this invention can vary widely depending upon the nature of the polymer, the silane, the processing or reactor conditions, the grafting or copolymerization efficiency, the ultimate application, and similar factors, but typically at least 0.5, preferably at least 0.7, weight percent is used. Considerations of convenience and economy are two of the principal limitations on the maximum amount of silane crosslinker used in the practice of this invention, and typically the maximum amount of silane crosslinker does not exceed 5, preferably it does not exceed 3, weight percent.

The silane crosslinker is grafted to the polymer by any conventional method, typically in the presence of a free radical initiator, e.g. peroxides and azo compounds, or by ionizing radiation, etc. Organic initiators are preferred, such as any one of the peroxide initiators, for example, dicumyl peroxide, di-tert-butyl peroxide, t-butyl perbenzoate, benzoyl peroxide, cumene hydroperoxide, t-butyl peroctoate, methyl ethyl ketone peroxide, 2,5-dimethyl-2,5-di(t-butyl peroxy)hexane, lauryl peroxide, and tert-butyl peracetate. A suitable azo compound is 2,2-azobisisobutyronitrile. The amount of initiator can vary, but it is typically present in an amount of at least 0.04, preferably at least 0.06, parts per hundred resin (phr). Typically, the initiator does not exceed 0.15, preferably it does not exceed about 0.10, phr. The weight ratio of silane crosslinker to initiator also can vary widely, but the typical crosslinker:initiator weight ratio is between 10:1 to 500:1, preferably between 18:1 and 250:1. As used in parts per hundred resin or phr, “resin” means the olefinic polymer.

While any conventional method can be used to graft the silane crosslinker to the polyolefin polymer, one preferred method is blending the two with the initiator in the first stage of a reactor extruder, such as a Buss kneader. The grafting conditions can vary, but the melt temperatures are typically between 160 and 260° C., preferably between 190 and 230° C., depending upon the residence time and the half life of the initiator.

Copolymerization of vinyl trialkoxysilane crosslinkers with ethylene and other monomers may be done in a high-pressure reactor that is used in the manufacture of ethylene homopolymers and copolymers with vinyl acetate and acrylates.

Moisture Source

The moisture source used in the practice of this invention includes at least one of moisture-containing filler or a compound that will release moisture upon exposure to heat or upon reaction with another compound.

Fillers that can be used as a moisture source in the practice of this invention include but are not limited to talc, calcium carbonate, organo-clay, glass fibers, marble dust, cement dust, feldspar, silica or glass, fumed silica, silicates, alumina, various phosphorus compounds, ammonium bromide, antimony trioxide, zinc oxide, zinc borate, barium sulfate, silicones, aluminum silicate, calcium silicate, titanium oxides, glass microspheres, chalk, mica, clays, wollastonite, ammonium octamolybdate, intumescent compounds, expandable graphite, and mixtures of two or more of these materials. The fillers may carry or contain various surface coatings or treatments, such as silanes, fatty acids, and the like. Halogenated organic compounds including halogenated hydrocarbons such as chlorinated paraffin, halogenated aromatic compounds such as pentabromotoluene, decabromodiphenyl oxide, decabromodiphenyl ethane, ethylene-bis(tetrabromophthalimide), dechlorane plus and other halogen-containing flame retardants. One skilled in the art will recognize and select the appropriate halogen agent consistent with the desired performance of the composition. To serve as a practical source of moisture for post-mold moisture cure, the moisture content of the filler is typically at least 0.1, more typically at least 1 and even more typically at least 10, weight percent based on the gross weight of the filler.

If present, the moisture-containing filler typically comprises at least 1, more typically at least 10 and even more typically at least 25, wt % of the composition. The only limit on the maximum amount of moisture-containing filler in the composition is the ability of the ethylene-vinylsilane copolymer matrix to hold the filler, but typically a general maximum comprises less than 70, more typically less than 65 and even more typically less than 60, wt % of the composition.

Compounds that will release moisture upon exposure to heat or upon reaction with another compound include but are not limited to organic acid and salts, esters and the like. For purposes of this invention alcohols are not a moisture source. Reactions that will generate moisture include but are not limited to pinacol re-arrangement (acid catalyzed), esterification, amide synthesis and decomposition, Hoffman degradation. If present, these compounds (either alone if moisture is generated by degradation or reaction with itself, e.g., Hoffman degradation or pinacol re-arrangement, or together if the compounds react with one another, e.g., esterification) typically comprises at least 0.2, more typically at least 0.5 and even more typically at least 1, wt % of the composition. The only limit on the maximum amount of these compounds in the composition is their affect on other properties of the injection molded article made from the composition, but typically a general maximum comprises less than 10, more typically less than 5 and even more typically less than 2, wt % of the composition.

Condensation Catalyst

The condensation catalyst used in the practice of this invention is typically a Lewis or Brønsted acid or base. Lewis acids are chemical species (molecule or ion) that can accept an electron pair from a Lewis base. Lewis bases are chemical species (molecule or ion) that can donate an electron pair to a Lewis acid. Lewis acids that can be used in the practice of this invention include the tin carboxylates such as dibutyl tin dilaurate (DBTDL), dimethyl hydroxy tin oleate, dioctyl tin maleate, di-n-butyl tin maleate, dibutyl tin diacetate, dibutyl tin dioctoate, stannous acetate, stannous octoate, and various other organo-metal compounds such as lead naphthenate, zinc caprylate and cobalt naphthenate. DBTDL is a preferred Lewis acid. Lewis bases that can be used in the practice of this invention include, but are not limited to, the primary, secondary and tertiary amines.

Brøsted acids are chemical species (molecule or ion) that can lose or donate a hydrogen ion (proton) to a Brønsted base. Brønsted bases are chemical species (molecule or ion) that can gain or accept a hydrogen ion from a Brønsted acid. Brønsted acids that can be used in the practice of this invention include the sulfonic acids.

The minimum amount of condensation catalyst used in the practice of this invention is a catalytic amount. Typically this amount is at least 0.01, preferably at least 0.02 and more preferably at least 0.03, weight percent (wt %) of the combined weight of ethylene-vinylsilane polymer and catalyst. The only limit on the maximum amount of condensation catalyst in the ethylene polymer is that imposed by economics and practicality (e.g., diminishing returns), but typically a general maximum comprises less than 5, preferably less than 3 and more preferably less than 2, wt % of the combined weight of ethylene polymer and condensation catalyst.

In the embodiments of the invention in which cure is initiated within the mold, typically a free radical initiator is used to promote in-mold curing. Suitable free radical initiators include the organic peroxides, more suitably those with one hour half lives at temperatures greater than 120° C. Examples of useful organic peroxides include 1,1-di-t-butyl peroxy-3,3,5-trimethylcyclohexane, dicumyl peroxide, 2,5-dimethyl-2,5-di(t-butyl peroxy) hexane, t-butyl-cumyl peroxide, di-t-butyl peroxide, and 2,5-dimethyl-2,5-di-(t-butyl peroxy) hexyne. Dicumyl peroxide is a preferred crosslinking agent. Additional teachings regarding organic peroxide crosslinking agents are available in the Handbook of Polymer Foams and Technology, pp. 198-204, supra. The peroxide can be added to the polymer by any one of a number of different techniques including, but not limited to, absorption into the polymer before it is compounded with the filler and condensation catalyst.

Additives

The compositions of this invention can contain one or more additives such as, for example, antioxidants (e.g., hindered phenols such as, for example, IRGANOX™ 1010 a registered trademark of Ciba Specialty Chemicals), phosphites (e.g., IRGAFOS™ 168 a registered trademark of Ciba Specialty Chemicals), UV stabilizers, cling additives, light stabilizers (such as hindered amines), plasticizers (such as dioctylphthalate or epoxidized soy bean oil), thermal stabilizers, mold release agents, tackifiers (such as hydrocarbon tackifiers), waxes (such as polyethylene waxes), processing aids (such as oils, organic acids such as stearic acid, metal salts of organic acids), colorants or pigments to the extent that they do not interfere with desired physical or mechanical properties of the compositions of the present invention. These additives are used in known amounts and in known ways.

Compounding/Fabrication

Compounding of the silane-functionalized ethylene polymer, moisture source, condensation catalyst and additives, if any, can be performed by standard means known to those skilled in the art. Examples of compounding equipment are internal batch mixers, such as a Banbury or Bolling internal mixer. Alternatively, continuous single or twin screw mixers can be used, such as a Farrel continuous mixer, a Werner and Pfleiderer twin screw mixer, or a Buss kneading continuous extruder. The type of mixer utilized, and the operating conditions of the mixer, will affect properties of the composition such as viscosity, volume resistivity, and extruded surface smoothness.

The components of the composition are typically mixed at a temperature and for a length of time sufficient to fully homogenize the mixture but insufficient to cause the material to gel (i.e., crosslink). The condensation catalyst is typically added to ethylene-vinylsilane polymer but it can be added before, with or after the additives, if any. Typically, the components are mixed together in a melt-mixing device. The mixture is then shaped into the final article, e.g., through injection molding. The temperature of compounding and article fabrication should be above the melting point of the ethylene-vinylsilane polymer but below about 250° C.

In some embodiments, either or both of the condensation catalyst and the additives are added as a pre-mixed masterbatch. Such masterbatches are commonly formed by dispersing the condensation catalyst and/or additives into an inert plastic resin, e.g., a low density polyethylene. Masterbatches are conveniently formed by melt compounding methods.

Once formulated, the composition is injected into a mold in which it is subjected to cure conditions for a sufficient period of time to at least partially cure the composition to a point that allows de-molding of the piece without detriment to the integrity of the article shape and/or its other physical properties. The formed article is then typically subjected to a post-mold cure period which takes place at temperatures from ambient up to but below the melting point of the polymer until the article has reached the desired degree of crosslinking. Generally, the time and conditions of the post-mold cure are such that the moisture cure of the article is completed before the article is put into use.

Articles of Manufacture

Injection-molded articles, particularly thick-walled, e.g., a thickness of at least 0.2, more typically of at least 0.5 and even more typically of at least 1, millimeters (mm) that can be prepared from the polymer compositions of this invention include electrical connectors, seals, gaskets, foams, footwear and bellows. In one embodiment these articles are elastomeric. These articles can be manufactured using known equipment and techniques.

The invention is described more fully through the following examples. Unless otherwise noted, all parts and percentages are by weight.

### SPECIFIC EMBODIMENTS

### Example 1

### Silane Grafting of Ethylene Polymers

Vinyltrimethoxy silane (VTMS) and LUPEROX 101 peroxide (2,5-dimethyl-2,5-di(t-butylperoxy)hexane available from Arkema) are mixed with another. ENGAGE 8200 (ethylene-butene copolymer available from The Dow Chemical Company, 5 melt index (MI), 0.875 g/cm³ density); and the VTMS/peroxide mixture are loaded into a PDL Brabender mixer in sufficient amounts to yield two 250-gram batches. The relative amounts of each component of the batch are reported in Table 1.

TABLE 1
Silane-g-Polymer

| Component | 1 |
|---|---|
| ENGAGE 8200 | 97.45 |
| VTMS | 2.5 |
| LUPEROX 101 | 0.05 |
| Total | 100 |

The temperature of the Brabender mixer is set at 100° C., the polymer resins are loaded and fluxed first, the VTMS/peroxide mixture is added, and then the entire contents of the mixer are mixed for 5 minutes at 15 revolutions per minute (rpm). The temperature of the mixer is then ramped to 180° C. and the contexts mixed for additional 10 minutes at 30 rpm. The mixture is then collected, pressed into plaques at room temperature, and sealed in aluminum foil bags.

Full Formulation Compounding

Full formulations (40 g) are formulated in the PDL Brabender mixer using the silane-grafted polymer resins prepared in Step 1 above and the remaining components identified in Table 2 below. The temperature of the Brabender mixer is set at 100° C., the silane-grafted polymer resin is loaded first followed by the fillers, and then the entire contents of the mixer are mixed for 10 minutes at 15 rpm. FASTCAT 4202 dibutyl tin dilaurate (DBTDL) available from M&T Chemicals, is added and the entire contents mixed for additional 5 minutes at 15 rpm. The mixture temperature is maintained at less than 130° C. The formulation is then collected, pressed into plaques at room temperature, and sealed in aluminum foil bags. The samples are frozen till further testing.

TABLE 2
Full Formulation Compositions

| | Example | | |
|---|---|---|---|
| Component (g) | 1 | 2 | 3 |
| VTMS-g-ENGAGE 8200 | 39.8 | 39.5 | 39.5 |
| Magnesium Oxalate | | 0.3 | |
| Dihydrate | | | |
| MARTINO LOL-111/LE | | | 0.3 |
| DBTDL | 0.1 | 0.1 | 0.1 |
| IRGANOX 1010 | 0.1 | 0.1 | 0.1 |
| Total | 40 | 40 | 40 |

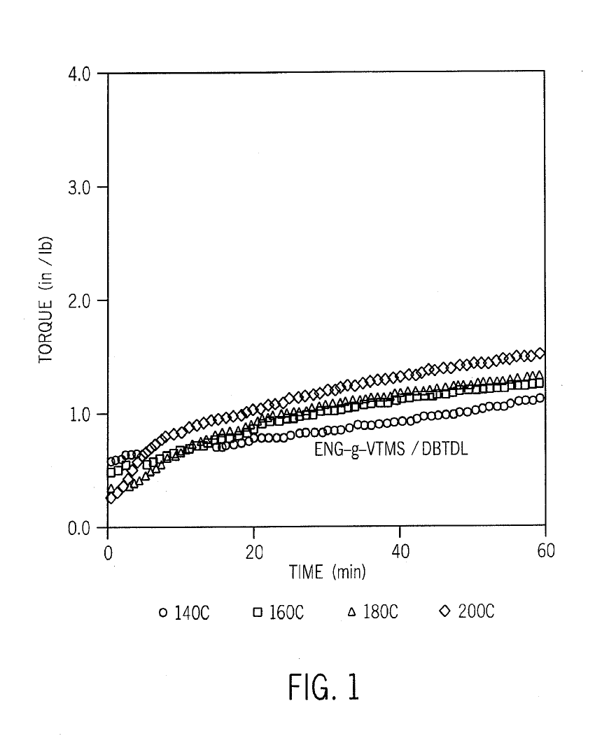

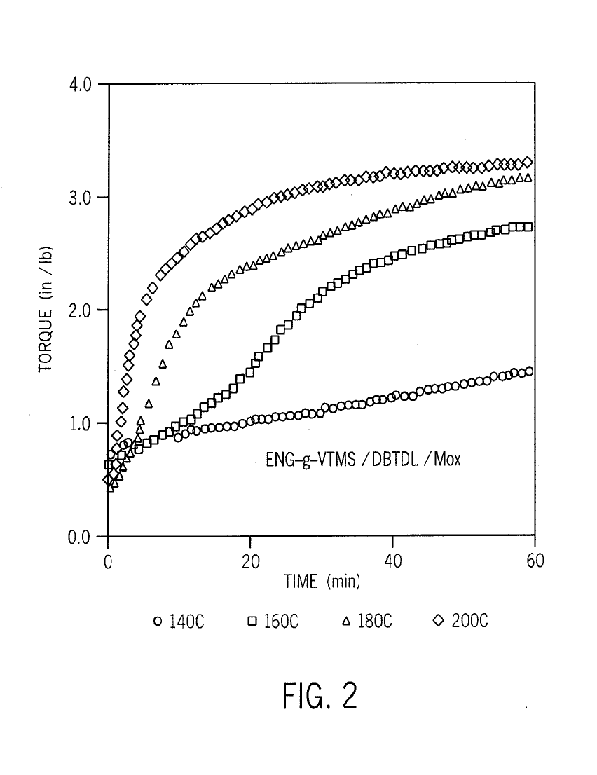

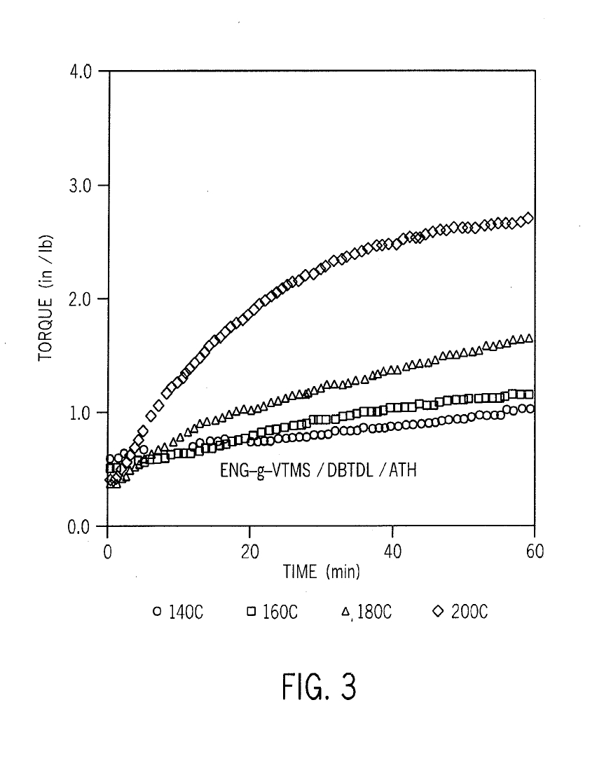

Moving Die Rheometer (MDR) analysis is performed using Alpha Technologies Rheometer MDR model 2000 unit. Testing Is based on ASTM D-5289 “Standard Test Method for Rubber—Property Vulcanization Using Rotorless Cure Meters”. The MDR analyses are performed using 4 to 5 grams of material. Samples are tested at 140° C., 160° C., 180° C. and 200° C. for 60 minutes and at 5 degrees arc oscillation. FIG. 1 shows the comparative torque increase for Example 1, 2 and 3. Example 1 shows the behavior of silane grafted systems in the presence of DBTDL. At all temperatures there is only a slight increase in torque with time indicating limited crosslinking especially due to dearth of water/moisture. In the case of Examples 2 and 3 due to the presence of magnesium oxalate dihydrate and MARTINOL OL111 or aluminum trihydrate (ATH) crosslinking proceeds as water molecules become available (FIGS. 2 and 3, respectively). The temperature of moisture release by the hydrate fillers dictates the temperature at which crosslinking starts, 160° C. for magnesium oxalate dehydrate, and 200° C. for MARTINOL OL111 or ATH.

Although the invention has been described with certain detail through the preceding specific embodiments, this detail is for the primary purpose of illustration. Many variations and modifications can be made by one skilled in the art without departing from the spirit and scope of the invention as described in the following claims.

What is claimed is:

1. An injection molding process for making a plastic article, the process comprising the steps of
A. Forming a moisture-curable composition comprising a
1. Silane-functionalized polyethylene,
2. Moisture source, wherein the moisture source excludes alcohols, and
3. Condensation catalyst;
B. Injecting the composition into a mold;
C. Subjecting the composition to conditions sufficient to
1. Release moisture from the moisture source, and
2. Partially cure the composition;
D. Removing the partially cured composition from the mold; and
E. Continuing the cure of the composition outside of the mold.

2. The process of claim 1 in which the plastic article comprises thick walls.

3. The process of claim 2 in which the silane-functionalized polyethylene is a silane-grafted EPDM or EPDM/POE blend.

4. The process of claim 3 in which the moisture source comprises at least one of moisture-containing filler and a compound that releases moisture upon heating or interaction with another compound.

5. The process of claim 4 in which the condensation catalyst is a Lewis acid or a Lewis base.

6. The process of claim 5 in which the moisture-curable composition further comprises a plasticizer.

7. The process of claim 6 in which (a) the moisture-curable composition comprises a compound that releases moisture upon heating or interaction with another compound, and (b) the composition is (i) compounded, melted and fed into an injection mold, and (ii) heated to a temperature sufficient to initiate release of the moisture from the moisture source.

8. The process of claim 7 in which the moisture-curable composition is subjected to drying conditions prior to being fed into the injection mold.

9. The process of claim 8 in which the moisture-curable composition comprises:
A. 1 to 70 wt % of the moisture source; and
B. 0.01 to 5 wt % of the condensation catalyst.

10. The process of claim 9 in which the moisture-curable composition further comprises a plasticizer.
